(19) United States
(12) Patent Application Publication
(10) Pub. No.: US 2005/0033676 A1
(43) Pub. Date: Feb. 10, 2005

(54) Method for evaluating relative investment performance from internal benchmarks

(76) Inventor: James Allen Charnley JR., Barrington, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/910,828

(22) Filed: Aug. 4, 2004

Related U.S. Application Data
(60) Provisional application No. 60/492,557, filed on Aug. 6, 2003.

(51) Int. Cl. G06F 17/60

(52) U.S. Cl. 705/35

(57) ABSTRACT

The method for evaluating investment performance among members of a population of investment alternatives from benchmarks derived internally from that population includes the step of first providing investment performance data for a population having a plurality of investment alternatives each having periodic investment returns. A point of population average for the average of the periodic investment returns and a point of population average for the variance of periodic returns for the investment alternatives population over an analysis period is calculated. The standard deviation of the average of periodic investment returns and the standard deviation of the variance of periodic investment returns for the population is computed. An equilibrium line (10) passing through both the point of population average of the average of periodic returns and the variance of periodic returns for the population and the point of one standard deviation from the point of performance for this population average is constructed. This equilibrium line (10) can then be employed to evaluate relative investment performance among the members of the population independently of market conditions because it is based on internal benchmarks. Since the equilibrium line (10) is not based on benchmarks that exist externally to the population, the measure of investment performance is unbiased and unaffected by market changes resulting in an improved method to evaluate investment performance.

### CROSS-REFERENCE TO RELATED APPLICATIONS

This application claims the benefit of U.S. Provisional Application Ser. No. 60/492,557 filed Aug. 6, 2003.

### FIELD OF THE INVENTION

This is a process to generate relative measures of investment performance that are consistent and unbiased regardless of market conditions. Relative measures of investment performance compare the performance of an investment alternative to a benchmark measure of average performance constructed either from a population of peers to that alternative or from the performance of one or more associated market indices. Existing measurement processes do not acknowledge or adjust for market conditions when the supply characteristics of a population of investment alternatives or a collection of one or more indices, demarcated by the performance distribution of this population or indices collection, does not equal the demand characteristics for the population or indices collection, as anticipated by economic theory. This type of market condition, common within the investment markets over the last forty years, creates false and nonsensical readings using existing measurement processes.

The primary use of this invention is for the measurement of investment performance for investment portfolios, collections of one or more investment alternatives. Owners of these investment portfolios have an active interest in evaluating the efficiency by which their portfolios have been managed which is a process implemented by comparing the investment performance over a past time period of the various selection decisions made regarding the portfolio's structure and makeup to the investment performance for a set of like selection alternatives or one or more market index whose performance is emblematic of that selection decision.

Existing measurement processes, as a general practice, utilize the performance characteristics of an investment asset of nominal or nonexistent investment risk, known as a “riskless asset”, along with the performance characteristics of these selection alternatives or associated indices to create a measure of relative performance that, by theory, is emblematic of investor demand across a range of investment risk. The use of such an “external benchmark”, which is a measure of investment performance for a benchmark that exists outside the comparison population, creates the possibility of generating false or nonsensical readings when market conditions do not match theoretical construct on which these processes are based.

There does exist an example of a method of measuring relative performance using only benchmarks that reside within a subject comparison population, which is the ‘efficiency line’, which is a measurement construct first proposed by Harry Markowitz in 1952 in his Modem Portfolio Theory (MPT), and in current use as a device to measure the relative performance of alternative strategies for allocating the assets of an investment portfolio. The efficiency line measurement process suffers from several structural and evaluative flaws that make its practical application as a performance measure problematic. The accommodation of these flaws has been the subject of prior-art designed as a corrective procedure, such as U.S. Pat. No. 6,003,018, issued to Michuad and of alternative methods for evaluating relative performance among a population of allocation alternatives, such as commonly owned U.S. Ser. No. 10/604,699 to the instant application.

Examples of existing measurement processes using external benchmarks that exclude the benchmark measure for a riskless asset are systems that match the performance characteristics of an investment alternative selected for inclusion within an investment portfolio or asset allocation strategy to a market-basket of risky external indices are the prior-art. These prior art patents include U.S. Pat. No. 6,125,355, issued to Bekaert and U.S. Pat. No. 6,021,397, issued to Jones. These processes also suffer from a structural and evaluative flaw that makes their practical use as performance measures problematic, and have also been the subject of alternative methods for evaluating investment selection alternatives, such as in commonly owned U.S. Ser. Nos. 10/777,312 and 10/6004,711 to the instant application.

The structural and evaluative flaw common to these existing processes lies in their extreme specificity. The algorithm that identifies an efficiency-line population only can “see” 1-2% of the asset allocation alternatives available to be made from a set of market sectors and evaluates those alternatives only against their peers at a specific point of risk, valid only for that specific point in time. The algorithm that identifies a market-basket of external indices whose risk characteristics matches an investment alternative only “sees” that specific alternative and is only valid to the performance of that alternative and for only that specific moment in time.

The requirement for a practical measurement of relative performance is to provide an evaluation inclusive of a full population of alternatives, using measurement criteria that are consistent over time. If the measure is created from less than a full population, it can never be confirmed as unbiased. If the measurement criteria change over time, they can never be confirmed as objective.

### BACKGROUND OF THE INVENTION

Investors acquire investment assets for the reward of the returns on investment that they generate over time. This return on investment is commonly characterized as an investment's “average return”, which is the average (either geometric or arithmetic) of a series of investment returns for a contiguous series of investment periods. The risk of acquiring the investment lies in the variance of those periodic returns around their average, either in terms of an investment's absolute level of variance (standard deviation of periodic returns) or in terms of its variance relative to the returns variance of a performance benchmark (beta). This relationship between investment reward and risk is generally illustrated on a simple, two-dimensional graph, as shown in FIG. 1. In FIG. 1, investment performance is defined as a function of investment return and investment risk where investment return is calculated as the average of the returns from a contiguous series of time-periods and investment risk as the variance of those time-period returns around their average. This relationship is illustrated as a ‘mean-variance’ graph as shown. In FIG. 1, the intersection of the lines for risk and return (point A) is the point of investment performance of an investment or investment strategy at a point in time.

The population of investment alternatives available to an investor is an “investment population” and this process is germane to evaluating the relative investment performance of the members of these investment populations.

To control investment risk, investors commonly hold their investment assets as an “investment portfolio”, a collection of one or more investments, and manage that collection to include investments of different and offsetting patterns and levels of periodic returns variance. This management technique is known as “asset diversification”, and is commonly implemented by first selecting for a strategy for dividing the portfolio assets among sectors of the investment market that have historically held uniquely different patterns and levels of periodic returns variance (“asset allocation strategy selection”) and then selecting for the individual investments from within each market sector with which to populate that allocation strategy (“investment selection”). These selection processes form the activity of “investment management”, namely, selecting the assets of an investment portfolio.

These processes of investment management are examples of “investment strategies” and populations of practitioners engaged in implementing similar types of investment strategies are “investment strategy populations”. Owners of investment portfolios often hire individuals or companies to manage the selection processes for their portfolios, and this process is also germane to evaluating the relative investment performance of the members of these investment strategy populations.

The basis for these definitions of investor demand and the resultant structure of investment supply are the tenets of Modern Portfolio Theory (MPT), a thesis written by Dr. Harry Markowitz in 1952 to explain investor behavior, which have become part of a small set of “first principles” for the investment industry. The tools for measuring relative performance contained in MPT are limited to the activity of asset allocation strategy selection and the investment strategy population that arises from this activity.

Dr. Markowitz set a graduate student, William Sharpe, to work in creating a tool for measuring performance differences within populations of investments and investment strategies involved in investment selection. The resultant measurement methodology, the Capital Assets Pricing Model (CAPM) makes up the remaining portion of “first principles” on which the investment industry bases their processes for evaluating relative performance differences between investments and investment strategies.

In MPT, the measurement of relative investment performance among a population of allocation strategy alternatives is benchmarked by inference. A sample of that population is identified that are those allocation alternatives whose performance is superior to their peers at each point of investment risk across the breadth of investment risk existent in the strategy population. This sample is found as a solution set to an algorithm that includes terms for comparing the covariance between the patterns of returns volatility for pairs of market sectors. The relative performance of the population not within this sample is not measured but, by construction, is assumed to be weaker than for the sample population at a given point of risk. Because the makeup of this sample is limited to only population members, it can be thought of as an example of an “internal benchmark”. On a mean-variance graph, the sample population forms an “efficiency line”, a collection of performance points residing at the top of the performance distribution for a population of asset allocation alternatives. The classical representation of the relationship between this efficiency-line 10 sample and its peers within a population of allocations strategy alternatives is illustrated in FIG. 2.

In CAPM, the measurement of relative performance among a population of investments or investment strategy alternatives is benchmarked against an algorithm thought to represent the sum of investor demand for investment performance. This algorithm uses the benchmarks of the risk and average return for a riskless asset and the risk and average return for either the population average or an asset of similar performance characteristics to the subject population to create a straight line equating the demanded return for each point of risk across the breadth of risk present within the population.

The riskless asset is most commonly defined in terms of as the risk and return for a short-term debt instrument that carries a government guarantee of repayment. It is also common to see this benchmark defined as the point of zero risk and zero return, which is a strategy akin to ‘hiding ones assets under a mattress’. Some applications identify this risk asset as one where there exists zero correlation between the pattern of periodic returns for the asset and the subject population of investment alternatives. For populations of investment and investment strategy alternatives that are made from assets other than government-guaranteed debt or mattress assets, this riskless asset represents an “external benchmark”. Since investors invest with the purpose of maximizing investment returns for the largest tolerable level of risk, populations for which the riskless asset can be considered to be an external benchmark are the prevailing form of investment and investment strategy populations within the investment industry.

In CAPM, the points of risk and return along the line drawn from the investment performance of the riskless asset and the average performance of the subject population or associated index make up a “market line”, which is a straight line marking the demand for investment return for each point of investment risk within the range of risk for the subject population. This is the common method for describing the average level of performance for a population of investment-selection alternatives. The classical representation of the relationship between this market line 12 and a population of investment or investment alternatives is illustrated in FIG. 3.

It is also common to combine the construct of a market line 12 with that of an efficiency line 10 drawn for a population of asset allocation alternatives in order to describe a population of asset allocation selection alternatives. Under this construct, the market line is assumed to represent investor demand and the point of tangency between the market and efficiency lines is assumed to be located at the performance level of the asset allocation strategy that most efficiently meets this demand. This “most-efficient” allocation strategy—the allocation strategy that satisfies both the conditions of investor demand and investment supply within an efficient and rational investment market—is characterized as the “market portfolio”. The classical representation of the relationship between the market and efficiency lines and the allocation strategy selection identified as the market portfolio is illustrated in FIG. 4.

The rationale behind the construction of a market line 12 is that it represents investor demand. The assumed character of that investor demand is that is begins at a point of return for an investment of zero risk, and that the level of demand for investment return increases with the level of investment risk. On a mean-variance graph, this assumption results in the drawing of an upward sloping line, as shown in FIG. 5. The market line evaluative measure assumes that the distribution of a population of investment and investment strategy alternatives conforms to the characteristics of investor demand. Those characteristics are that investor demand is a linear relationship between investment return and risk that starts at a point of zero risk and is a positively increasing function where the demand for investment return increases as investment risk increases.

Differences in the relative performance of the members of a population of investment or investment strategy alternatives are calculated from this market line. The points of the line are considered to be a series of “market returns”, which is the return demanded by the market at each point of risk across the breadth of risk within the population. An alternative's “differential return” or “excess return” is calculated as the difference between that alternative's average return and the market return at the alternative's point of risk. On a mean-variance graph, this differential return is the vertical distance of an alternative's point of investment performance from the market line, as illustrated in FIG. 6.

In FIG. 6, investment alternatives A and B have generated the same average return for an analysis period. Investment A, however, has generated that average return with less periodic returns variance than investment B. Investment A's distance above the market line 12 is greater as is its differential return for that analysis period. By this measurement system, investment A's investment performance is said to be stronger than investment B's.

The practical issue with the use of measurement methods using a market line is that under other than theoretical market conditions is that the relationship between the performance characteristics of the riskless asset and a point of average population or associated-index performance undergoes constant change. As a general drawback, this condition makes the relative measurement of performance between population alternatives subjective to external market conditions. As a more specific problem, during market periods when the average return for the population average or associated index is at or below that of the riskless asset, this measurement method results in a flat or downward sloping market line and a measurement of relative performance that is either nonsensical or absolutely false.

In view of the foregoing, there is a need for a method for evaluating investment performance that is unbiased and unaffected by market conditions. And in view of the shortcomings of the lone existing method of measuring relative performance using internal population benchmarks, there is a need for method of evaluating investments that is more accurate and reliable than prior art methods. There is also a need for a method of evaluating investment performance to acknowledge and adjust for market conditions for an investment portfolio, collections of investments and one or more investment alternatives.

### SUMMARY OF THE INVENTION

The present invention preserves the advantages of prior art methods for evaluating relative investment performance. In addition, it provides new advantages not found in currently available methods and overcomes many disadvantages of such currently available methods.

The invention is generally directed to a novel method for evaluating relative investment performance based on internal benchmarks. More specifically, the present method is well-suited for providing a method for evaluating investment performance that is unbiased.

The present invention solves the aforementioned problems associated with the prior art. The process of this invention corrects for these problem by using only “internal benchmarks”—measurements of performance generated exclusively from within the subject comparison population. It is not the only process that uses a system of internal benchmarks, or that generates performance measurements without the use of an external index such as a riskless asset. However, it is the only practical solution to the problem posed by the shortcomings of existing external-benchmark based processes.

The present invention is unique among internal-benchmark alternatives because it is created from whole-population measures of investment performance that remain consistent over time.

This invention is used to enhance the operating results of existing processes to select investments from book-valued populations of alternatives disclosed in the following commonly owned and invented applications to the present application, U.S. Ser. Nos. 10/079,022 (to evaluate investment portfolio performance); 10/079,022; 10/605,293; 10/604,711; 10/604,699; and 10/777,313. It can also be used in processes for selecting or evaluating the relative performance for members of populations of market valued investments, such as populations of publicly-traded securities—or any other populations whose evaluation is contingent on the comparison of relative values of risk and reward among the members of that population. Finally, it can be a corrective procedure for general financial modeling applications that compare the utility of an investment or business strategy over a range of possible risks that contain the measurement of a “market” or other external risk.

It is a further object to provide a method for evaluating investment performance that is unaffected by market conditions.

Another object of the invention is to provide a method of evaluating investments that is more accurate than prior art methods.

There is a further object for a method of evaluation investment performance to acknowledge and adjust for market conditions.

Yet another object of the present invention is to provide a method of evaluating investment performance for an investment portfolio, collections of investments and one or more investment alternatives.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a prior art graph showing investment performance defined as a function of investment return and investment risk;

FIG. 2 is a prior art graph showing an efficiency line drawn from an equation that calculates a segment of a population of asset allocation strategy alternatives;

FIG. 3 is a prior art graph showing the relationship between a market line and a population of investment alternatives;

FIG. 4 is a prior art graph showing the use of an efficiency line and market line as a benchmark of relative performance for a population of asset allocation strategy alternatives;

FIG. 5 is a prior art graph showing the relationship between a market line and theories of investor demand;

FIG. 6 is a prior art graph showing the relationship of a market line and the measurement of relative investment performance between members of a population of investment alternatives;

FIG. 7a is a graph of a market line in accordance with the present invention showing the relationship of a market line and the measurement of relative investment performance between members of a population of investment alternatives over an analysis period when the average return for the population average or an associated index benchmark approaches the average return for the riskless asset;

FIG. 7b is a graph of a market line in accordance with the present invention showing the relationship of a market line and the measurement of relative investment performance between members of a population of investment alternatives over an analysis period when the average return for the population average or an associated index benchmark drops below the average return for the riskless asset;

FIG. 8 is a graph of a market line in accordance with the present invention showing relative investment performance calculated by a popular purveyor of performance databases for populations of mutual funds for two funds with identical period average returns over an analysis period when the average return for an associated index benchmark used to construct the market line dropped below the average return for the riskless asset used for that line;

FIG. 9 is a graph in accordance with the present invention showing a market line inverted for analysis periods when the average return for point of average return for the population average or an associated index is below the average return of the riskless asset;

FIG. 10a is a is a graph in accordance with the present invention showing an equilibrium line is drawn using only internal benchmarks, from the point of lowest risk and average return to the point of highest risk and average return for the population;

FIG. 10b is a graph in accordance with the present invention showing a variant of the graph of FIG. 10a wherein an equilibrium line is drawn using only internal benchmarks from a segment of a population generating the lowest risk and average return to a segment of the population generating the highest risk and average return, each segment made up of population members generating similar levels of risk and return;

FIG. 10c is a graph in accordance with the present invention showing a regression line calculated from the distribution of investment performance for a population of investment alternatives;

FIG. 11a is a graph in accordance with the present invention showing the distribution of investment performance for a population of investment alternatives and calculated averages for investment return and investment risk for that population;

FIG. 11b is a graph in accordance with the present invention showing an equilibrium line that is dependent only on internal benchmarks wherein it is drawn using the calculated averages of investment return and investment risk and the calculated standard deviations of investment return and investment risk for a population of investment alternatives;

FIG. 12 is a graph in accordance with the present invention showing an equilibrium line 10 drawn using the calculated averages of investment return and investment risk and the calculated standard deviations of investment return and investment risk for a population of investment alternatives whose point of average for average return over an analysis period falls below the average return for a riskless asset;

FIG. 13 is a graph in accordance with the present invention showing an equilibrium line 10 of positive slope drawn using the calculated averages of investment return and investment risk and the calculated standard deviations of investment return and investment risk for a population of investment alternatives whose point of average for average return over an analysis period is equal to the average return of a riskless asset; and

FIG. 14 is a graph in accordance with the present invention showing and equilibrium line 10 that is drawn using the calculated averages of investment return and investment risk and the calculated standard deviations of investment return and investment risk for a population of investment alternatives used to determine relative investment performance between members of a population of investment alternatives.

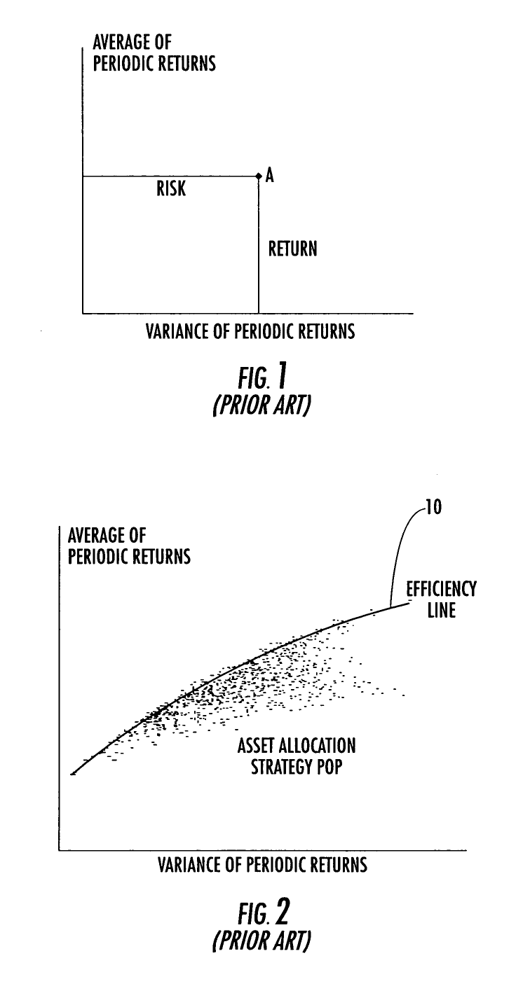

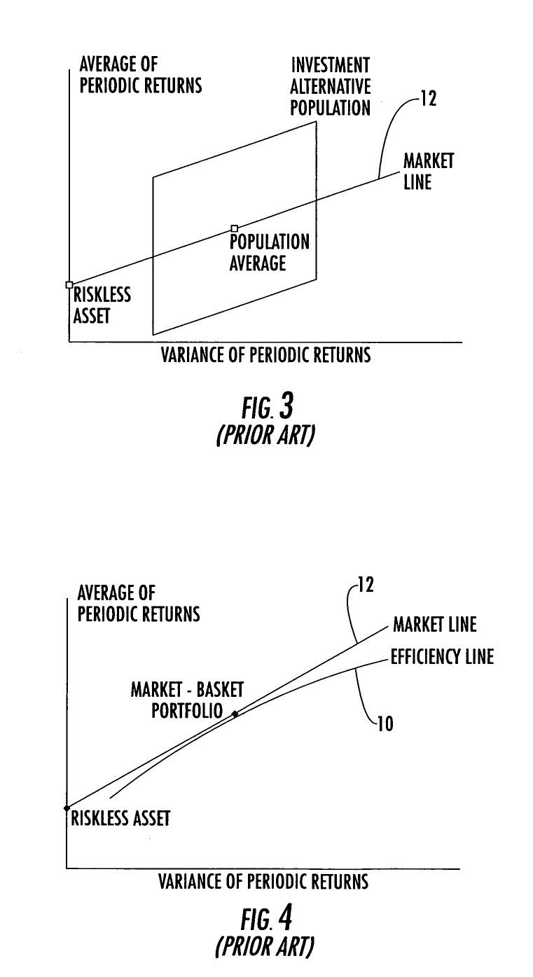

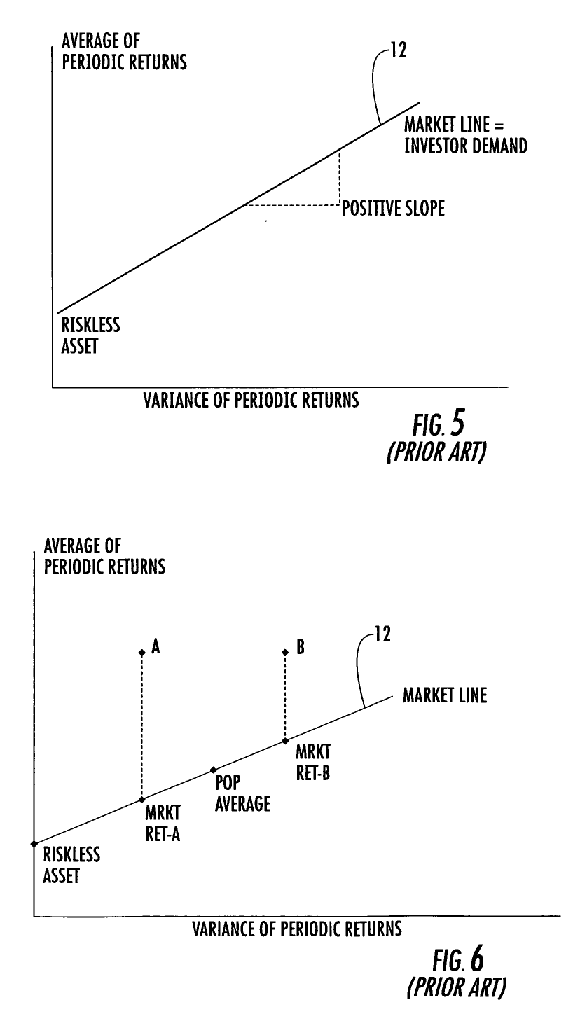

### DETAILED DESCRIPTION OF THE PREFERRED EMBODIMENT

The utility of the market line mechanism, as formulated under the tenets of the CAPM, and other measurement methods that use benchmarks that are external to a population of investment alternatives for determining relative investment performance is undermined by the practical realities of the investment markets. As a general issue, the slope of a market line 12 is contingent on the relationship between the return and risk levels of the riskless asset and the benchmark return used to describe the population average. This condition adds a level of subjectivity into the measurement of relative performance. As the point of average population return over an analysis period moves closer to the average return for the riskless asset, the slope of the market line flattens and the performance of those alternatives of greatest risk within the population appear stronger relative to those alternatives among the lower risk portion of the population. As the point of average population risk moves away from the risk for a riskless asset, the slope of the market line also flattens and the performance of those alternatives of greatest risk within the population appear stronger relative to those alternatives among the lower risk portion of the population. Thus for a series of relative performance measurements taken for a subject population of investment alternatives over successive analysis periods, one of two investment alternatives whose relative measures of return and risk remain constant over those analysis periods can be alternatively judged to be stronger or weaker than its partner alterative as the population average level of return and risk changes over time.

This issue of subjectivity becomes more critical during analysis periods when the point of average population return used in constructing the market line 12 resides at the same level or below the point of return for the riskless asset over the analysis period. This creates a market line that is either flat or downward sloping, and makes the results of measurements of relative investment performance taken from this line nonsensical. The measurements of relative investment performance calculated from market lines 12 under these conditions contravene the fundamental tenets of investor demand and of the relative value of investments.

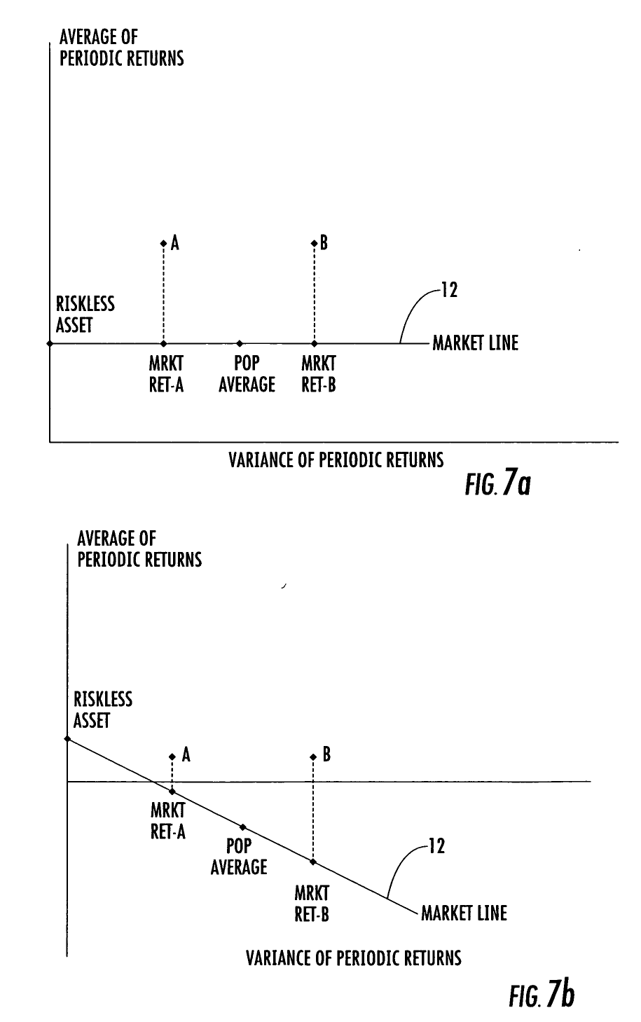

As example, in an analysis period when the point of average return for the population average is equal to that of the riskless asset the resultant market line 12, as drawn on a mean-variance graph, is parallel to the x-axis. Two alternatives within that population that have generated equal average returns, when judged by their respective distances from this market-line are evaluated as operating at identical levels of investment performance regardless of differences between those alternatives in the level of periodic returns variance experienced in generating those average returns, as seen in FIG. 7a.

In FIG. 7a, the average returns for the riskless asset and population average are identical for an analysis period. This produces an illogical evaluative result in comparing the relative investment performance for investments A and B that also produced an identical average return but at different levels of investment risk.

Investment A generated less investment risk than investment B, but its differential return—the distance of its performance point from the market line 12 is identical to investment B's. By the construct of CAPM and a market line 12, both investments would be judged to have identical investment performance for the period.

As another example, for an analysis period when the average return for the point of population average performance is below that of the riskless asset, the resultant market-line 12, as drawn on a mean-variance graph, is of negative slope. Of the two alternatives within that population that have generated equal average returns, the riskier alternative—the one that has experience the greater variance in periodic returns—is judged as operating at a stronger investment performance, when judged by its distance from this market-line, than the alternative experiencing the lesser variance in periodic returns, FIG. 7b.

In FIG. 7b, it can be seen that under these conditions the differential return for the riskier of (2) investments generating identical levels of average return (investment B) appears greater than for the less risky investment, such as investment A. By the construct of CAPM and a market line, investment B be judged to have had the stronger investment performance for the period.

Neither of these outcomes illustrated in FIG. 7a or FIG. 7b makes sense as a measure of relative investment performance. Finance theory anticipates market returns will follow investor demand and that risky markets will always generate a higher level of returns than a riskless asset—a market line 12 will never be flat or downward sloping. However, as the experience of the last forty years teaches that academic theory is not always supported by empirical evidence.

To test for the presence of downward sloping market lines 12, the public securities market can be divided into (5) market sectors each comprising populations of securities that have generated uniquely similar levels and patterns of investment risk over the last forty years—(4) representative of risky markets and (1) of a riskless-asset market. Each of the risky-market sectors can be identified by an associated index—and the riskless sector by the yield on the 90-day Treasury bill.

Each of these market sectors represents a population of investment selection alternatives. There exist (165) quarters between March 1962 and December 2003 in which a 12-month analysis period can be formulated and a market line 12 drawn between the return of the 90 day Treasury bill and each of the five market-sector 12-month return averages, as represented by the 12-month return of their associated index.

The experience of last forty years has been fairly uniform. The market lines 12 drawn for each of the (4) risky market-sectors have been downward sloping for a little over ⅓ of these 12-month analysis periods since March 1962. This means that measures of relative performance for the investment alternatives contained in these risky market-sector populations have been perfectly false and contrary to common sense evidence of relative investment performance strength one out of three times.

TABLE
Analysis Period Where Market Line is of Negative Slope

| | | | % 1-year Analysis |
|---|---|---|---|
| | | | Periods Where Market |
| | | | Line is of Negative |
| | | | Slope (quarters ending |
| Market | | | March 1962 to |
| Sector | Population | Index | December 2004) |
| Aggressive | small and high-growth | S&P500 Market | 58/165 = 35% |
| | domestic equities | | |
| Above | mid to large and income | NASDAQ Market | 60/165 = 36% |
| Average | oriented domestic | | |
| | equities | | |
| Average | fixed income | Lehman Brothers | 65/165 = 39% |
| | securities | Aggregate Bond | |
| Contrarian | foreign and precious | MSCI-EAFE | 61/165 = 37% |
| | metal securities | | |
| Riskless | money-market | Yield | NA |
| | securities | 90Day Tbill | |

The instances of a flat market line for the (165) one-year analysis periods since quarter ending March 1962 are much less, but can nevertheless occur. For those 12-month analysis periods when the market-sector population's average return, as indicated by the return of its associated index, is between 1.00% and (−) 1.00% of the return of the 90-day Treasury bill, the resultant market line drawn is essentially flat, and differences in investment risk between investment alternatives within the market-sector become unimportant in determining relative investment performance.

TABLE
Analysis Period Where Market Line is of Zero Slope

| | | | % 1-year Analysis |
|---|---|---|---|
| | | | Periods Where |
| | | | Market Line is of |
| | | | Zero Slope |
| | | | (quarters ending |
| Market | | | March 1962 to |
| Sector | Population | Index | December 2004) |
| Aggressive | small and high-growth | S&P500 | 4/165 = 2% |
| | domestic equities | Market | |
| Above | mid to large and | NASDAQ | 7/165 = 4% |
| Average | income oriented | Market | |
| | domestic equities | | |
| Average | fixed income | Lehman | 17/165 = 10% |
| | securities | Brothers | |
| | | Aggregate | |
| | | Bond | |
| Contrarian | foreign and precious | MSCI-EAFE | 4/165 = 2% |
| | metal securities | | |
| Riskless | money-market | Yield | NA |
| | securities | 90Day Tbill | |

There exist (2) primary commercial purveyors of performance databases for populations of mutual funds that have been in operation since the 1980's—Steele Systems and Morningstar, Inc. Mutual funds are a type of public security and populations of mutual funds are considered populations of investment alternatives.

Both purveyors provide within their database comparative statistics of investment performance for populations of funds based on a market line 12—and neither give any indication of being aware of the measurement issue posed by a market line of negative slope.

Both Morningside and Steele Systems construct their market lines from the covariant measure of periodic returns variance—beta. They both use the 90 day Tbill as their riskless asset and the S&P500 Market Index as their “population average” second market line point. Under a market line construction using beta, the vertical distance of a point of performance for an investment alternative from the market line—its differential return—is defined as ‘alpha’. The measurement of relative investment performance is the same for investment alternatives measured in terms of their alphas—the larger the alpha, the stronger the investment performance.

The relationship between a market line and (2) investments with identical average returns but different levels of periodic returns variance is the same whether measured as in terms of alpha or differential return—both benchmarks measure the vertical distance between an investment's return and that of a point on the market line of equal risk. The investment with the smallest beta—the less risky of the two—has the strongest investment performance. If two investments of equal average return reside on either side of a market line, the one whose beta is smaller than the market line beta at that level of average return should have a larger alpha than the one whose beta is larger than the market line beta at that level of average return.

The 3-year analysis period ending March 2003 was one that produced a negatively sloped market line for the Morningstar and Steele databases. The average annual return for the S&P500 Market Index was (−) 16.10%; the average return for the Tbill index was (+) 3.35%. There existed (2) mutual funds—the Muirfield Flex-fund (FLMFX) and the T. Rowe Price New Horizons fund (PRNHX) whose average returns for the analysis period were virtually identical. The level of periodic returns variance for T Rowe Price fund was three times higher than for the Muirfield fund—a beta of 1.50 versus 0.47 for the Muirfield fund—and by the tenets of MPT and theories of investor demand, the T Rowe Price fund should have been ranked lower than the Muirfield fund in terms of relative investment performance. Nevertheless, Steele Systems calculated a much higher alpha—a stronger investment performance—for the T Rowe Price fund, assigning an alpha equal to 0.97 for the T Rowe Price fund versus an alpha of (−) 0.69 for the Muirfield fund.

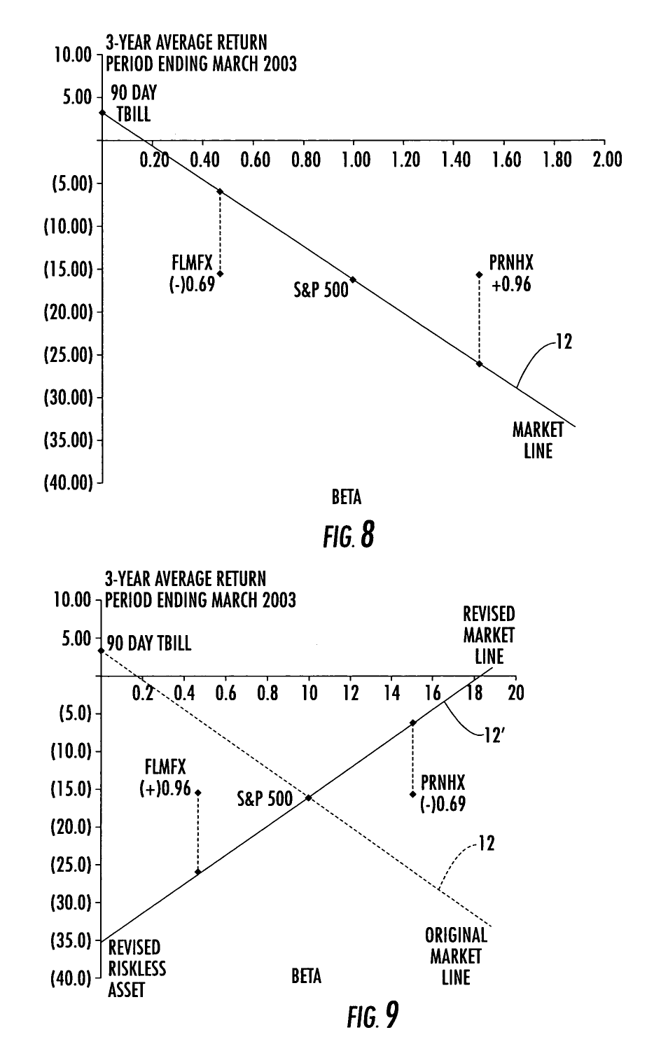

To visualize how this mistake could occur, it is helpful to see how these two funds and the market line 12, as constructed by Steele Systems and Morningstar, appear on a mean-variance graph drawn for the 3-year period ending March 2003, as shown in FIG. 8—the market line for the analysis period is of negative slope. This occurrence of miscalculating relative investment performance for two funds of equal investment return in an analysis period when the market line is of negative slope is confirming evidence that the shortcomings of the market line construct are not anticipated by the investment industry.

Because the market line 12 is downward sloping, the fund of less risk and greater investment performance value appears below the market line and is given a negative alpha rank (−0.69)—the fund of greater risk and less investment performance value appears above the market line and is given a positive alpha rank (+0.97) by Steele Systems.

Clearly, a process to evaluate the relative performance of investments and investment strategies needs to be created that does not give false measurements whenever a performance distribution of a population of investments or investment strategies contravenes the tenets of investor demand and fails to an upward sloping market line from a point of zero risk.

In accordance with the present invention, there are a number of methods to solve for measurement problem discussed above. The solution to the problem of a market line of either zero or negative slope is obvious—one must substitute for a market line whose slope may turn flat of negative in response to market conditions, with one whose slope will consistently remain positive regardless of market conditions. The best way to implement this solution, however, is much less obvious.

A market line must have some basis in reality. Its function is to identify the investor demand function for a population of investment choices. It is axiomatic that this demand function must generate a line of positive slope on a mean-variance graph—greater risk must produce greater reward.

A simple option would be to just invert the market line when it is negative. On a mean variance graph, one just doubles the vertical distance between the average return for the riskless asset and the average return for the point of performance for the population average and subtracts that distance from the original point of return for the riskless asset. This point becomes the ‘revised average return’ for the riskless asset—as shown in FIG. 9.

Still referring to FIG. 9, the market line 12 for the 3-year analysis period ending March 2003 is invested and the relative investment performance (alpha) for two investments of equal average returns recalculated from the inverted line. The investment of small investment risk ends up with a positive alpha (+0.97) and the one with larger risk for the period a negative alpha (−0.69).

There are (2) issues that impinge upon the usefulness of this process is correcting for periods when the market line is of negative or zero slope. First, the revised point of performance for the riskiess asset is an arbitrary benchmark—it has no basis in the empirical data for the analysis period. The performance measurements generated by the inverted line that results from the construction have a nice symmetry with their measurements off the original market line 12, but for other than that reason, an inverted market line 12′ really has not validity beyond that symmetry.

Second, the inverted market line 12′ does not solve for the issue of a market line of zero slope. For those analysis periods and investment populations where the average return for the point of performance for the population average and average return for the riskless asset are equal, there is no purpose for an inversion procedure—+zero slope=(−) zero slope. Regardless of the inversion constant, the problem of measuring for investment performance differences between investment alternatives of different levels of investment risk remains for analysis periods and investment populations that generate a market line of zero slope.

A more complete solution to the problem of measuring for performance differences during periods of negative or zero market line slope needs to be based on the following (2) attributes:

1. The line drawn on a mean-variance graph to denote average investment performance across a population must be calculated from benchmarks that are internal to the population. The inclusion of an external benchmark—such as the proverbial riskless asset—will always raise the risk of a line of negative slope.

2. The line drawn must also be based on the performance distribution characteristics of the population. Basing an average on the distribution characteristics of a population eliminates the issue of arbitrariness—the empirical fact is that the supply of investment alternatives within the population is the performance distribution of that population. An average based on this distribution is an average representative of investment supply—as opposed to a market line that is representative of investor demand. To differentiate this average built from investment supply, we will call it the population's “equilibrium line 10”.

In markets where investor demand equals investment supply—analysis periods of positive market line slope—the equilibrium line 10 and market line 12 are close or identical averages. In markets where the conditions of investment supply do not meet the conditions of investor demand—analysis periods of negative or zero market line slope—the performance distribution of a population can be the only valid context within which to measure for relative performance and the equilibrium line 10 the only relevant measure of a population's performance average. From this viewpoint, the convention of a market line can be seen as one type of equilibrium line 10 that is valid only for market conditions and analysis periods when investment alternative supply equals investor demand.

With these (2) attributes in mind, there exist several ways of constructing this distribution average:

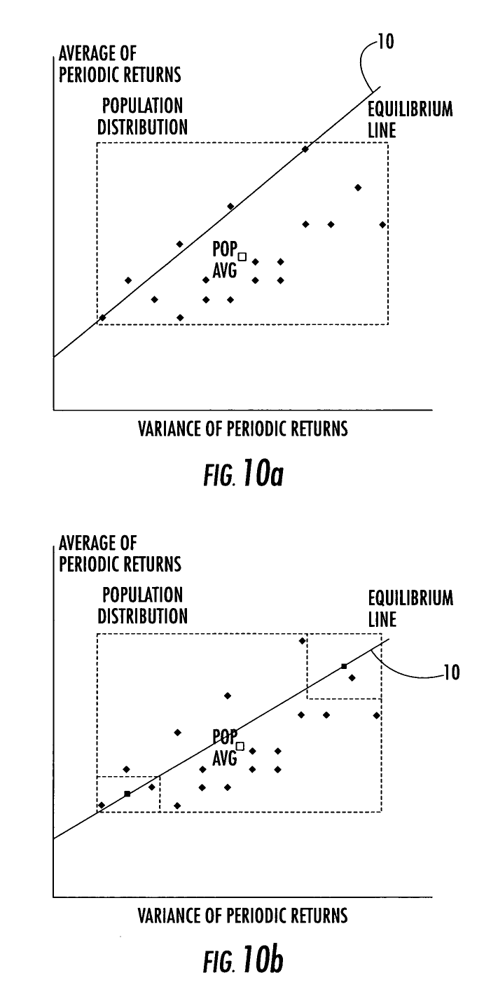

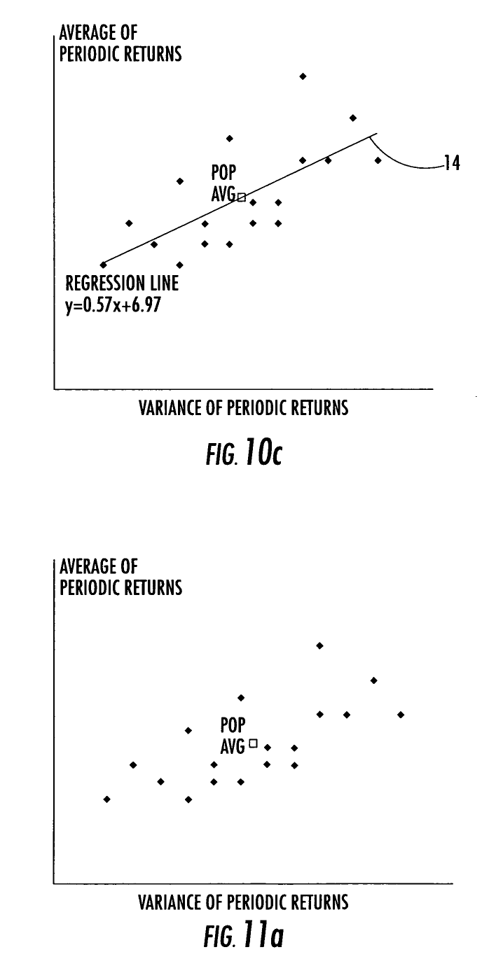

1. A first option is to calculate the points of lowest investment risk and highest investment return for a population and draw an equilibrium line 10 between the two points (or variants of this scheme, which is the lowest average return to the highest average return, the lowest returns variance to the highest returns variance, etc.). This alternative method has a fatal flaw in that there exists a high probability that these two performance measures selected will not be representative of the distribution of the population in that they are outliers that will skew the equilibrium line 10 and make any relative measures of performance coming from that line spurious. This is illustrated in FIG. 10a.

2. A variant on this option is to divide the population performance distribution into areas of equal population size by grouping population members with similar levels of average return and returns variance. A line denoting the population average performance can be drawn between a point of average performance for the group located in the population distribution of highest returns and variance and the average performance for a group located at the area of lowest return and returns variance. Although this option lessens the risk of misspecification by a line drawn from performance outliers, it does not totally eliminate it, shown in FIG. 10b.

Ultimately, the only options available for plotting the average population performance basaed on its performance distribution are those that incorporate the point of average population risk and average population return into their construction. There is an existing option for this. Economists and other analysts are fond of performing the procedure of linear regression on a performance distribution for a population of investment alternatives. Such a regression procedure is commonly termed a ‘least-squared method’ for fitting a straight line and differs from efforts to construct a market line in that it does not assume y-axis intercept—the regression does not include a point of performance for a riskless asset.

FIG. 10c illustrates the results from such a regression line 14. There exist (2) issues with this approach. First, there is no guarantee that such a procedure won't return a regression line that runs parallel to the x-axis, an equilibrium line 10 that has zero slope or is downward sloping, an equilibrium line 10 that has negative slope. Second, such a methodology requires that one assume that the performance distribution around the line is symmetrical—or the line cannot be straight. As disclosed in commonly owned and invented patent application titled “Method to Select Investments in Book-valued Collective Investment Funds”, U.S. Ser. No. 10/079,022, there exists at least one large population of investment alternatives—market-sector populations of book-valued investment funds—for which this assumption of a stable symmetrical population distribution is invalid.

Preferred Method to Solve for Measurement Problem

The preferred method of drawing an equilibrium line 10 that is dependent only on internal benchmarks is to find for the average and standard deviation of the risk and return for a population and use these two sets of benchmarks to construct the line as follows:
a. Calculate the point of average for the average of periodic returns [avg(avgret)] and the point of average for the variance of periodic returns [avg(varret)]for a population of investments or investment strategies [popavg].
b. Compute the standard deviation of the average of periodic returns [stdev(avgret)] and the standard deviation of the variance of periodic returns [stdev(varret)] for this population of investment alternatives.
c. Construct an equilibrium line as a straight line passing through the following (2) points of performance for the population:
   1) the points of average for the average of periodic returns and the variance of periodic returns for a population
      (x,y)=[popavg]=([avg(varret)],[avg(avgret)])
   2) a point (1) standard deviation from the point of performance for the population average
      (x,y)=[popavg+stnd]=(([avg(varret)]+[stdev(varret)], ,[avg(avgret)]+[stdev(avgret)])

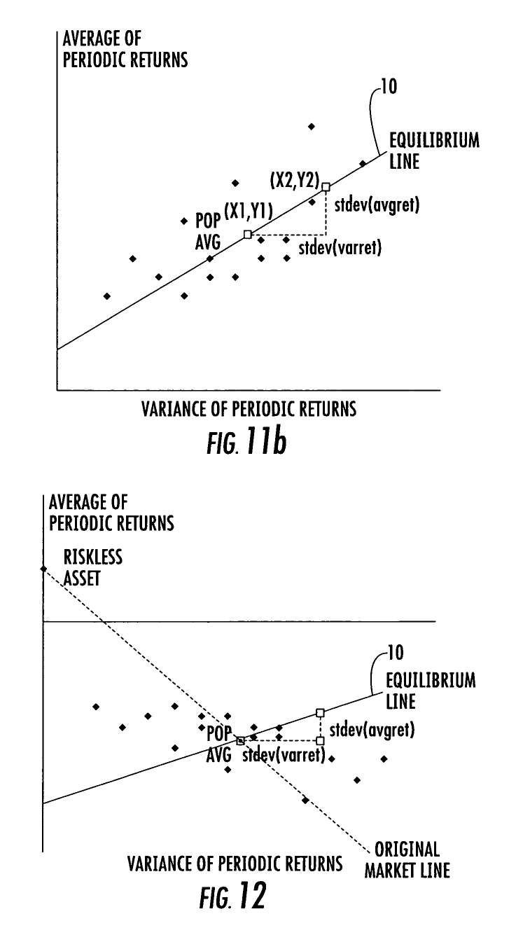

This construct will ensure an equilibrium line 10 that is representative of both the distribution and average performance characteristics of a population, while ensuring a line of positive slope regardless of market conditions because the measure of standard deviation is always a positive number. This equilibrium line 10 is shown in FIG. 11.

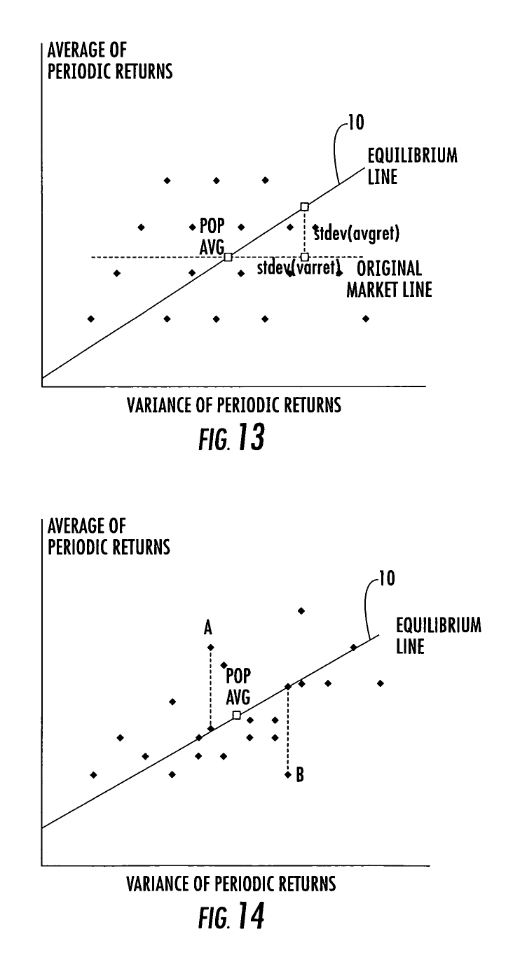

This construction method for creating an equilibrium line 10 also works in producing a line of positive slope for a population whose point of average for average returns falls below the return of a riskless asset, as seen in FIG. 12, and for a population whose point of average for average returns is equal to the return of a riskless asset, as illustrated in FIG. 13.

After constructing an equilibrium line the procedure for computing the measurement of relative investment performance among members of the investment alternative population is the same as used for a market line evaluative measure. The slope and y-axis intercept is calculated for the line according the following formula:
slope=[stdev(avgret)]/[stdev(varret)]
y intercept=[avg(avgret)]−([stdev(avgret)]*[avg(varret)]/[stdev(varret)])

These terms are used in a standard linear equation to calculate the point of average return along the equilibrium line 10 for each point of risk within the population known as the “equilibrium return”. The relative investment performance for a member of the population—its differential return, excess return or alpha—is computed by subtracting the equilibrium return at that member's point of risk from its average return for the analysis period, as shown in FIG. 14.

The average return for Investment A in FIG. 14 resides above the equilibrium return at its point of risk, having a positive differential return, and is the stronger of the two investments in terms of investment performance. The average return for Investment B, in FIG. 14, resides below the equilibrium return at its point of risk, having a negative differential return, and is the weaker of the two investments in terms of investment performance.

These and other modifications and variations occurring to those skilled in the art are intended to fall within the scope of the appended claims.

1. A method for evaluating relative investment performance for members of a population of investment alternative from benchmark measures derived internally from that investment alternative population, comprising the steps of:
providing investment performance data for a population having a plurality of investment alternatives each having periodic investment returns;
calculating a point of population average for an average of the periodic returns and a point of population average for a variance of periodic returns for the population of investment alternatives;
computing a standard deviation of the average of periodic returns and a standard deviation of the variance of periodic returns for the population of investment alternatives;
constructing an equilibrium line passing through both a point identified as the population average of the average of periodic returns and the population average of the variance of periodic returns and a point identified as residing one standard deviation from the point of population average of the average of periodic returns and one standard deviation from the population average of the variance of periodic returns for the population of investment alternatives.

2. The method of claim 1, wherein the point marking the population average of the average of periodic returns and the population average of the variance of periodic returns is calculated according to the formula of
(x,y)=[popavg]=([avg(varret)],[avg(avgret)]).

3. The method of claim 1, wherein the point one standard deviation from the point of performance for a population average is calculated according to the formula of
(x,y)=[popavg+stnd]=(([avg(varret)]+[stdev(varret)], ,[avg(avgret)]+[stdev(avgret)]).

4. The method of claim 1, wherein the population of investment alternatives is comprised of market-valued investment securities.

5. The method of claim 1, wherein the population of investment alternatives is comprised of book-valued funds and investment securities.

6. The method of claim 1, wherein the population of investment alternatives is comprised of private placement, business investment and venture-capital alternatives.

7. The method of claim 1, wherein the plurality of investment alternatives is comprised of practitioners engaged in the selection functions required for investment portfolio management.

8. The method of claim 1, wherein the variance of periodic returns around their average is calculated as the standard deviation of periodic returns for an investment alternative.

8. The method of claim 1, wherein the variance of periodic returns around their average is calculated as beta—the covariance of periodic returns for an investment alternative with the periodic returns of a benchmark asset, divided by the variance of periodic returns for that benchmark asset.

9. The method of claim 1, wherein the plurality of investment alternatives are classified in a plurality of market sectors.

5. The method of claim 4, wherein the investment alternatives are classified in five market sectors.

6. The method of claim 1, wherein the equilibrium line is based on benchmarks that are internal to the population.

7. The method of claim 1, wherein the equilibrium line is based on performance distribution characteristics of the population.

8. The method of claim 1, further comprising the step of:
determining a distribution average of the population.

9. The method of claim 8, wherein the distribution average is determined by calculating points of lowest investment risk and highest investment return for the population and creating an equilibrium line therebetween.

10. The method of claim 8, wherein the distribution average is determined by dividing the population average into areas of equal population size by grouping securities in the population with similar levels of average return and returns variance and creating an equilibrium line between a point of average performance for a group located in a distribution of highest returns in the population and variance and average performance for a group located at a area of lowest return and returns variance.
